(19) United States
(12) Patent Application Publication
(10) Pub. No.: US 2017/0149298 A1
(43) Pub. Date: May 25, 2017

(54) ARMATURE WINDING FOR ELECTRICAL ROTATING MACHINE

(71) Applicant: KABUSHIKI KAISHA TOSHIBA, MINATO-KU (JP)

(72) Inventors: MASAFUMI FUJITA, YOKOHAMA (JP); TAKASHI UEDA, YOKOHAMA (JP); TAKAAKI HIROSE, YOKOHAMA (JP); MASASHI OKUBO, KAWASAKI (JP); TAKERU SAITO, TOKYO (JP)

(73) Assignee: KABUSHIKI KAISHA TOSHIBA, MINATO-KU (JP)

(21) Appl. No.: 15/358,758

(22) Filed: Nov. 22, 2016

(30) Foreign Application Priority Data
Nov. 24, 2015 (JP) 2015-228446

(51) Int. Cl. H02K 3/14

(52) U.S. Cl. CPC H02K 3/14

(57) ABSTRACT

According to one embodiment, there is provided an armature winding for an electrical rotating machine. The armature winding includes a plurality of coil pieces partly housed in a plurality of winding slots formed in a stator core, each coil piece comprising a plurality of wire conductors which are formed to be transposed by being twisted, wherein at least some of coil-piece end portions protruding outward from side surfaces of the stator core are configured to have different wire conductor transposition angles according to an amount of impinging fluxes or an impinging flux density.

### CROSS-REFERENCE TO RELATED APPLICATIONS

This application is based upon and claims the benefit of priority from Japanese Patent Application No. 2015-228446, filed Nov. 24, 2015, the entire contents of which are incorporated herein by reference.

### FIELD

Embodiments described herein relate generally to an armature winding for an electrical rotating machine.

### BACKGROUND

A stator for an electrical rotating machine is configured as depicted in FIG. 7. FIG. 7 is a sectional schematic view depicting a configuration of a part of the stator for an electrical rotating machine, specifically, the vicinity of one winding slot of the stator, as seen in an axial direction. The stator for the electrical rotating machine has a stator core 3 composed of laminated iron plates and an armature winding 2. The stator core 3 is, for example, provided with a plurality of winding slots 10 positioned above in FIG. 7 and extending along a rotating axis of a rotor not depicted in the drawings and is also provided with a plurality of ventilating ducts arranged in a radial direction and not depicted in the drawings. Each of the winding slots 10 houses the armature winding 2.

The armature winding 2 comprises upper coil pieces 2c and lower coil pieces 2d each including a large number of stacked wire conductors 5. Each of the wire conductors 5 is formed to be transposed by being twisted around an extending direction of the winding slot 10 within a range in which the wire conductor 5 is housed in the winding slot 10. In a typical example, the wire conductor 5 is formed to be transposed through 360° and short-circuited at endmost portions of coil-piece end portions protruding outward from opposite side surfaces of the stator core 3. FIG. 8 is a perspective view depicting an example of transposition of the wire conductors 5. As depicted in FIG. 8, a multi-wire conductor is formed by twisting individual wire conductors 5 at a predetermined transposition pitch, for example, so as to sequentially pass the wire conductors 5 from row 1 to row 2.

When an alternating current flows through the armature winding 2 having such a multi-wire conductor, leakage fluxes M traversing the winding slot 10 in a circumferential direction are generated as depicted in FIG. 7. A voltage is induced between the wire conductors in each of different portions of the multi-wire conductor in a longitudinal direction. In a certain wire conductor pair, when the induced voltage between the wire conductors significantly varies all along the length of the wire conductors, a large circulating current flows through the wire conductor pair, which forms a closed loop, that is, a large current circulates through the wire conductor pair. This leads to an increased current loss and an increased amount of heat generated inside the wire conductors.

For the armature winding and field winding in the electrical rotating machine, strict upper temperature limits are set based on the heat resistance performance of insulators included in the armature winding and field winding. The electrical rotating machine needs to be designed such that the temperatures are kept equal to or lower than the specified values.

Thus, to make the induced voltage between the wire conductors substantially uniform all along the length of the multi-wire conductor to prevent flow of a circulating current, the wire conductors 5 are formed to be transposed using various methods.

Now, conventional transposition of wire conductors will be described with reference to FIG. 9 and FIG. 10. Transposition of the wire conductors is achieved by twisting the wire conductors with respect to the extending direction of the winding slot (specifically, sequentially varying the positions of the wire conductor). During twisting, a certain wire conductor is considered to rotationally move in a circle around a sectional center of the coil piece. The degree of transposition is represented by the angle of the rotational movement. The angle in this case is referred to as a “wire transposition angle”. Furthermore, 360° transposition refers to transposition in which each wire conductor passes through all the positions in a coil piece section and reaches a position located at an opposite end of the winding slot and which is the same as the start point of the twisting.

FIG. 9 is a schematic diagram of wire transposition of an armature winding in a conventional electrical rotating machine as viewed in the circumferential direction. The upper coil pieces 2c and the lower coil pieces 2d are formed such that each wire conductor is transposed through 360° by being twisted around the extending direction of the winding slot in the stator core 3 within the range in which the wire conductor is housed in the winding slot.

At each of a connection-side coil-piece end portion 2b-1 and a counter-connection-side coil-piece end portion 2b-2, the wire conductors of the coil-piece end portions are connected together in series (short-circuited) with shorting bars 13. The upper coil pieces 2c and the lower coil pieces 2d are connected together (short-circuited) with the shorting bars 13 at the counter-connection-side coil-piece end portion 2b-2. Although not depicted in the drawings, the upper coil pieces 2c and the lower coil pieces 2d are actually also connected together (short-circuited) with the shorting bars 13 at the connection-side coil-piece end portion 2b-1 to form a winding with a plurality of turns. FIG. 9 depicts interlinkage fluxes 16 (such as fluxes 16+ and 16−) between two typical wire conductors 5a and 5b. Symbols in FIG. 9 (filled circles and crosses) indicate the directions of fluxes generated at the moment when a certain current flows and represent a relation for an induced voltage induced by the interlinkage fluxes. The filled circles indicate that the direction of the flux is toward the reader with respect to the sheet of the drawing. The crosses indicate that the direction of the flux is away from the reader with respect to the sheet of the drawing. The sum of the flux 16+ and the fluxes 16− is uniform within the core, offsetting the induced voltage between the wire conductors 5a and 5b induced by the interlinkage fluxes in the winding slot 10.

On the other hand, fluxes 16x and 16y including a variety of leakage fluxes are generated in the areas of the coil-piece end portions 2b-1 and 2b-2 outside the winding slot 10. That is, 360° transposition is applied inside the winding slot but no transposition is applied in the areas of the coil-piece end portions 2b-1 and 2b-2 outside the winding slot 10. Consequently, an unbalanced voltage results from leakage fluxes generated at the ends of the stator core 3, causing a circulating current to flow through the wire conductors 5a and 5b in the direction of arrows in FIG. 9. FIG. 11 is a schematic sectional view illustrating leakage fluxes generated in the coil-piece end portions 2b-1 and 2b-2. At the coil-piece end portions 2b-1 and 2b-2, a complicated distribution is present which includes fluxes 16a created by a current flowing through the winding conductor itself and fluxes 16b created by other windings and the rotator (a combination of fluxes By in a radial direction of the electrical rotating machine and fluxes Bc in a circumferential direction of the electrical rotating machine). The synthesized leakage fluxes induce a circulating current.

As described above, leakage fluxes at the ends of the stator core 3 induce a voltage between the wire conductors at the ends of the winding conductor. Then, a circulating current flows through the wire conductors, leading to a current loss. To reduce the loss, the position of the wire conductor may be reversed at the opposite ends thereof to reverse the directions of voltages induced at the opposite ends of the same wire conductor to offset the voltages. This can be achieved by applying 540° transposition, that is, one-and-a-half rotations of transposition, in the winding slot. However, the 540° transposition needs to set a transposition pitch in the stator core 3 so as to make the transposition pitch near each end of the core half the transposition pitch in a central portion of the core, and may thus be difficult to achieve in terms of manufacturing.

Due to these problems, techniques are also known which adopt a “90°/360°/90′ transposition” configuration in which transposition is also applied to the coil-piece end portions. In this winding, the wire conductors are formed to be transposed through 90° at both coil-piece end portions and through 360° in the winding slot in the stator core.

A configuration is also known which is intended to further suppress the circulating current in the wire conductors to level off a temperature gradient in the wire conductors, in which (i) transposition with a wire transposition angle of less than 360° or (ii) transposition including an idling area with no transposition is applied in the winding slot, and in which the wire transposition angle in the coil-piece end portions is set to between 60° and 120°.

In the above-described prior art, the circulating current caused by the unbalanced voltage between the wires can be suppressed. However, large-scale numerical calculations indicate that the interlinkage fluxes between the wire conductors at the opposite ends thereof vary depending on various conditions.

FIG. 12A and FIG. 12B are graphs indicating results of numerical analysis of impinging fluxes on coil-piece end portions in a several-hundred-MW turbine generator. FIG. 12A illustrates an impinging flux density of impinging fluxes on the coil-piece end portions positioned at ends of a phase belt (the coil-piece end portions facing a boundary portion between different phase belts). FIG. 12B illustrates the density of impinging fluxes on the coil pieces in a central portion of the phase belt. In FIG. 12A and FIG. 12B, the impinging flux density [T] in a circumferential direction of the electrical rotating machine is denoted by Bc. The impinging flux density [T] in a radial direction of the electrical rotating machine is denoted by Bv(abs). The impinging flux density [T] in a flow direction of current is denoted by Bi. An axis of abscissas in FIG. 12A and FIG. 12B indicates that a distance [m] along the coil-piece end portion in a longitudinal direction. A position of 2 [m] corresponds to the position of a portion where the coil-piece end portions are connected together. Positions of 0 [m] and 4 [m] each correspond to the position of an end (a side surface portion of the core) of an area of the coil-piece end portion which is not housed in the core slot.

As depicted in FIG. 12A and FIG. 12B, the impinging flux density of fluxes on the upper coil pieces is distributed at larger values than the impinging flux density of fluxes on the lower coil pieces. A comparison between FIG. 12A and FIG. 12B indicates that the end of the phase belt illustrated in FIG. 12A involves a higher impinging flux density than the central portion of the phase belt illustrated in FIG. 12B.

FIG. 12C is a graph illustrating the amount of fluxes on the upper coil pieces 2c for each coil piece in the phase belt. In FIG. 12C, fluxes corresponding to Bc described above are denoted by φc(abs), and fluxes corresponding to By described above are denoted by φv(abs). Fluxes in the flow direction of current are denoted by φi(abs). Of coil numbers 1 to 12, coil numbers 1 and 12 correspond to coil pieces positioned at the respective phase belts. The graph in FIG. 12C indicates that the amount of impinging fluxes increases with decreasing distance to the end of the phase belt.

FIG. 13 is a schematic development depicting one phase of armature winding in a conventional electrical rotating machine. When the lengths of the coil-piece end portions 2b-1 and 2b-2 are denoted by L1 and L2, L1 and L2, corresponding to the connection side and the counter-connection side, respectively, may differ from each other due to a difference in winding pitch or a difference in a structure for fixedly supporting the core. In FIG. 13, the winding pitch P1 of the connection-side coil-piece end portion 2b-1 is one slot pitch smaller than the winding pitch P1 of the counter-connection-side coil-piece end portion 2b-2. Thus, the coil-piece end portion 2b-1 is shorter than the coil-piece end portion 2b-2. The difference in winding pitch between the connection side and the counter-connection side may be larger than 1 depending on a manner of connection, resulting in a difference in length and impinging flux density between the coil-piece end portions. The winding pitch may be varied among the coil-piece end portions on the same side, and also in this case, the impinging flux density varies according to the length of the coil-piece end portion.

As described above, when the amount of impinging fluxes varies according to the arrangement of the coil pieces or the structure of the electrical rotating machine, the resultant circulating current and circulating current loss may vary, that is, a rise in the temperature of the coil pieces may vary.

When the temperature of the coil pieces locally sharply rises, insulators need to be provided with a heat resisting property, leading to an increased size of the electrical rotating machine and degraded long-term reliability. Thus, the rise in the temperature of the coil pieces needs to be leveled off.

Under the circumstances, it is desired to provide an armature winding for an electrical rotating machine which enables a reduction in a circulating current between the wire conductors induced by a difference in interlinkage fluxes between the wires in the coil piece, allowing suppression of an increase in loss from the armature winding and local overheat.

### BRIEF DESCRIPTION OF THE DRAWINGS

FIG. 1 is a schematic development of one phase of an armature winding for an electrical rotating machine in a first embodiment;

FIG. 2 is a schematic diagram illustrating wire transposition of the armature winding for the electrical rotating machine in the first embodiment;

FIG. 3 is a graph illustrating a relation between a wire transposition angle and a circulating current loss;

FIG. 4 is a schematic development of one phase of an armature winding for an electrical rotating machine in a second embodiment;

FIG. 5 is a schematic diagram illustrating wire transposition of the armature winding for the electrical rotating machine in the second embodiment;

FIG. 6 is a schematic diagram illustrating wire transposition of an armature winding for an electrical rotating machine in a third embodiment;

FIG. 7 is a schematic sectional view illustrating leakage fluxes in a winding slot in the armature winding;

FIG. 8 is a perspective view depicting an example of transposition of wire conductors;

FIG. 9 is a schematic diagram illustrating wire transposition of an armature winding for an electrical rotating machine in the prior art;

FIG. 10 is a schematic diagram illustrating wire transposition of an armature winding for an electrical rotating machine in the prior art;

FIG. 11 is a schematic sectional view illustrating leakage fluxes generated at coil-piece end portions;

FIGS. 12A, 12B, and 12C are graphs illustrating results of numerical analyses of impinging fluxes on the coil-piece end portions; and

FIG. 13 is a schematic development of one phase of an armature winding for an electrical rotating machine in the prior art.

### DETAILED DESCRIPTION

Hereinafter, embodiments will be described with reference to the accompanying drawings.

In general, according to one embodiment, there is provided an armature winding for an electrical rotating machine. The armature winding includes a plurality of coil pieces partly housed in a plurality of winding slots formed in a stator core, each coil piece comprising a plurality of wire conductors which are formed to be transposed by being twisted, wherein at least some of coil-piece end portions protruding outward from side surfaces of the stator core are configured to have different wire conductor transposition angles according to an amount of impinging fluxes or an impinging flux density.

### First Embodiment

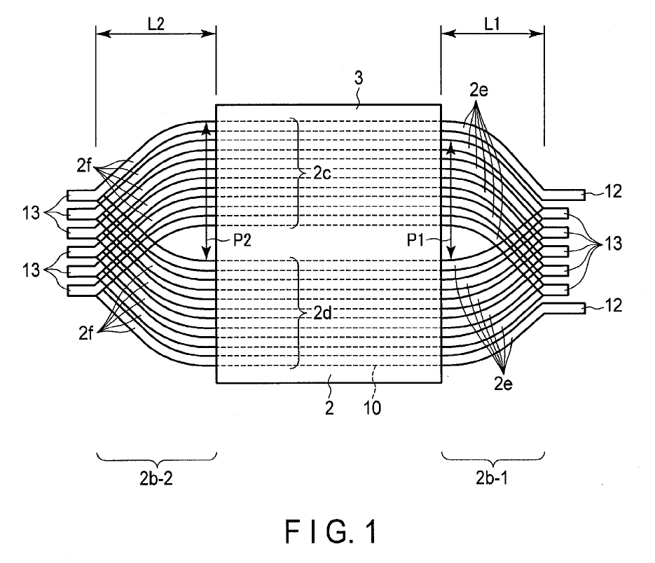

First, a first embodiment will be described with reference to FIGS. 1 to 3.

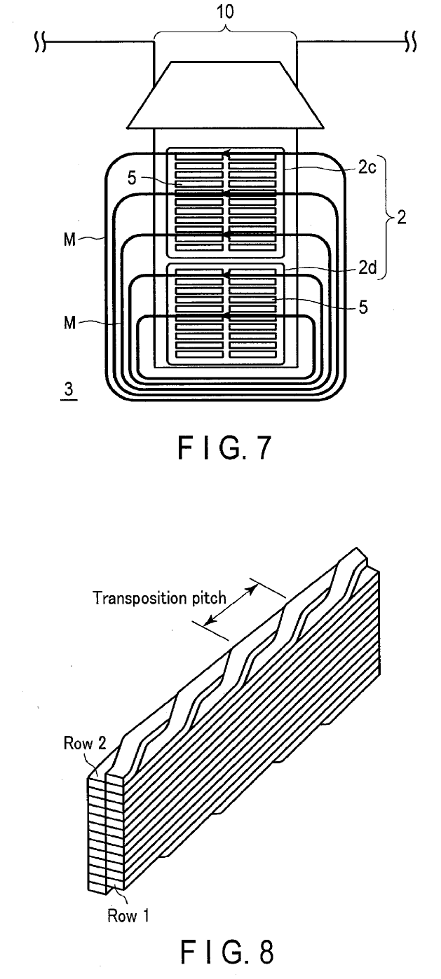

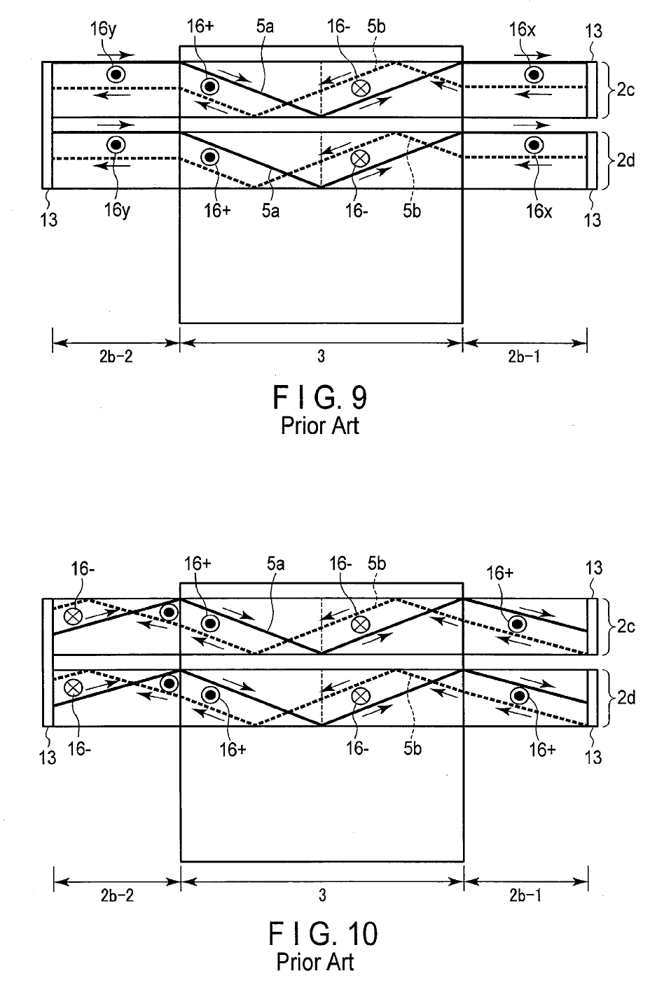

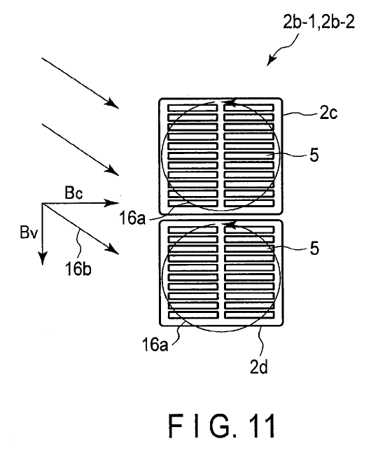

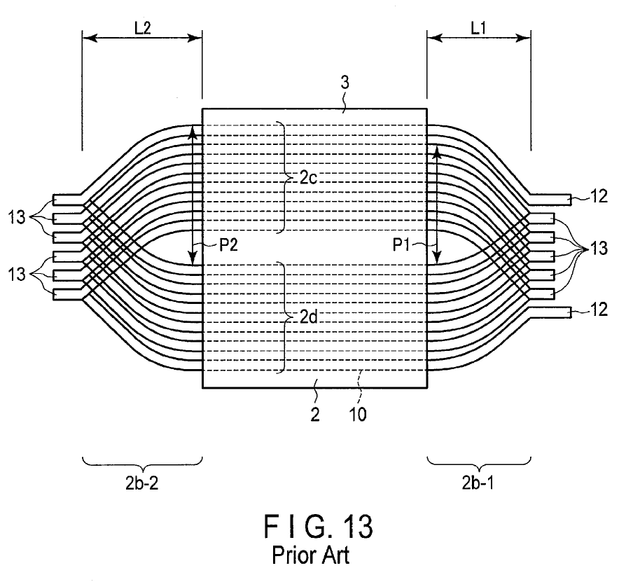

FIG. 1 is a schematic development depicting one phase of an armature winding for an electrical rotating machine in the first embodiment. Elements in FIG. 1 which are the same as the corresponding elements in FIGS. 7 to 13, described above, are denoted by the same reference numerals.

The armature winding for the electrical rotating machine depicted in FIG. 1 is housed in the form of two layers in each of a plurality of winding slots 10 provided in an armature core 3 composed of laminated iron plates. Specifically, an armature winding 2 in each phase comprises upper coil pieces 2c and lower coil pieces 2d partly housed in winding slots 10. The upper coil pieces 2c are housed in the winding slots 10 on an opening side, and the lower coil pieces 2d are housed in the winding slots 10 on a bottom side.

Coil-piece end portions of the armature winding 2 are connected together in series with shorting bars 13 at an endmost portion of the coil-piece end portion. On a counter-connection side of the coil-piece end portion 2b-2, coil-piece end portions 2f of the upper coil pieces 2c and the lower coil pieces 2d are connected together through the shorting bars 13. At a connection-side coil-piece end portion 2b-1, coil-piece end portions 2e of the upper coil pieces 2c and the lower coil pieces 2d except the coil-piece end portions 2e connected to winding lead-out portions 12 are connected together through the shorting bars 13.

A winding pitch P1 of the connection-side coil-piece end portion 2b-1 is one slot pitch smaller than a winding pitch P2 of the counter-connection-side coil-piece end portion 2b-2. A length L2 of the counter-connection-side coil-piece end portion 2b-2 is larger than a length L1 of the connection-side coil-piece end portion 2b-1.

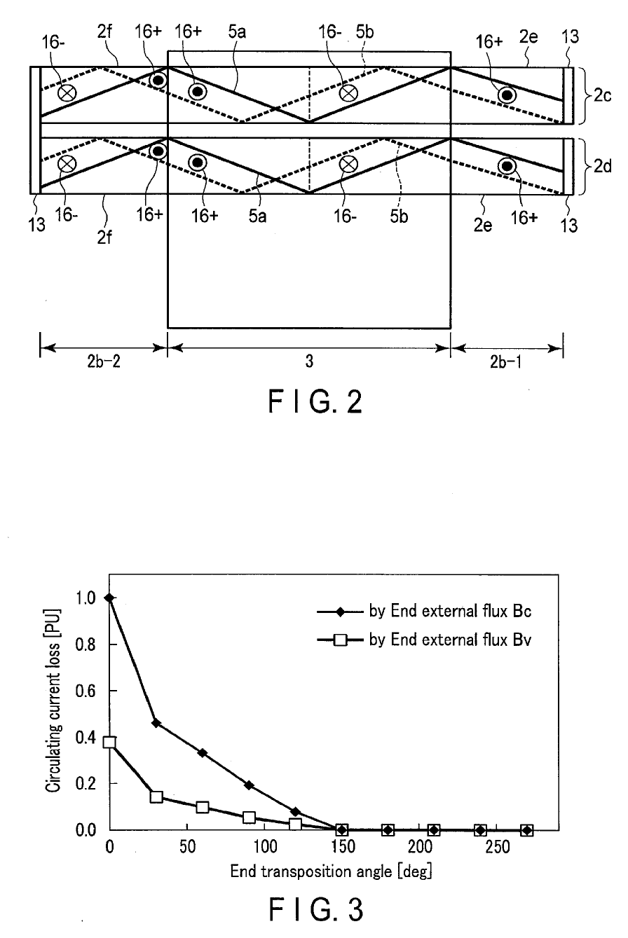

FIG. 2 is a schematic diagram illustrating wire transposition of the armature winding 2 in the electrical rotating machine in the first embodiment as viewed in a circumferential direction.

The upper coil pieces 2c and the lower coil pieces 2d are formed such that each wire conductor is transposed through 360° by being twisted around the extending direction of the winding slot in the stator core 3 within the range in which the wire conductor is housed in the winding slot. That is, a wire transposition angle is 360°.

At the connection-side coil-piece end portion 2b-1, the wire transposition angle of the coil-piece end portion 2e is 90°. At the counter-connection-side coil-piece end portion 2b-2, the wire transposition angle of the coil-piece end portion 2f is 135°. That is, the armature winding is configured to set the wire transposition angle of the counter-connection-side coil-piece end portion 2b-2 larger than the wire transposition angle of the connection-side coil-piece end portion 2b-1.

FIG. 2 depicts interlinkage fluxes 16 (such as fluxes 16+ and 16−) between two typical wire conductors 5a and 5b. Symbols in FIG. 2 (filled circles and crosses) indicate the directions of fluxes generated at the moment when a certain current flows and represent a relation for an induced voltage induced by the interlinkage fluxes. The filled circles indicate that the direction of the flux is toward the reader with respect to the sheet of the drawing. The crosses indicate that the direction of the flux is away from the reader with respect to the sheet of the drawing. The sum of the flux 16+ and the fluxes 16− is uniform within the core, offsetting the induced voltage between the wire conductors 5a and 5b induced by the interlinkage fluxes in the winding slot 10. The fluxes 16+ and 16− are also generated in the areas of the coil-piece end portions 2b-1 and 2b-2.

FIG. 3 is a graph illustrating a relation between the wire transposition angle and a circulating current loss at the coil-piece end portions.

The graph plots the circulating current loss with respect to the wire transposition angle in a case where the amount of interlinkage fluxes between wire conductors is uniform, for fluxes By in a radial direction of the electrical rotating machine and for fluxes Bc in a circumferential direction of the electrical rotating machine. The axis of abscissas represents the wire transposition angle [degrees], and the axis of ordinate represents the circulating current loss [PU].

The graph indicates that, for example, when a wire transposition angle of 90° in the prior art is increased to 135° as in the present embodiment, the circulating current loss with respect to the same amount of fluxes is reduced approximately to half. The degree of the reduction in loss varies according to design conditions or operating conditions for the electrical rotating machine. Thus, the optimum wire transposition angle is desirably determined under individual conditions by numerical analysis. However, in general, the trend illustrated in FIG. 3 may remain substantially unchanged even with a change in conditions, and thus, the difference in wire transposition angle is desirably within the range of 30° to 60°.

As described above, in the first embodiment, the wire transposition angle of the counter-connection-side coil-piece end portion 2b-2, which involves a long coil-piece end portion and a large amount of impinging fluxes, is larger than the wire transposition angle of the coil-piece end portion 2b-1. Consequently, the circulating current loss at the counter-connection-side coil-piece end portion 2b-2 can be reduced to allow a rise in temperature to be leveled off, providing a more reliable armature winding for an electrical rotating machine and a more reliable electrical rotating machine.

For a reduction in loss, a possible general loss can be reduced by increasing the wire transposition angle at all the coil-piece end portions. However, an increased wire transposition angle reduces a transposition pitch, making processing of wires difficult and increasing the possibility of impairing insulation applied to the wires. Therefore, the number of coil pieces with an increased wire transposition angle is desirably minimized. Consequently, the armature winding and the electrical rotating machine are made more reliable by increasing the wire transposition angle only for coil pieces for which an increase in wire transposition angle is particularly necessary as in the present embodiment.

When the wire transposition angle of the long coil-piece end portion is increased as in the present embodiment, the transposition pitch can also be kept constant by increasing the wire transposition angle by an amount equal to the difference in length. Thus, this is a more reliable configuration also in terms of manufacture of the armature winding.

The present embodiment is not limited to the illustrated configuration. Of course, the absolute value of the wire transposition angle can be selected freely to some degree by setting an appropriate difference in wire transposition angle between the coil-piece end portions in accordance with design conditions for the electrical rotating machine.

In the illustrated example of the present embodiment, each wire is transposed from end to end of the coil-piece end portion. The transposition may be partly omitted or the transposition angle may be partly changed. For example, instead of being uniform (for example, at 135°, the wire transposition angle of the coil-piece end portion 2f may be zero or may be changed within an area from the core side to the middle of the coil-piece end portion 2f.

### Second Embodiment

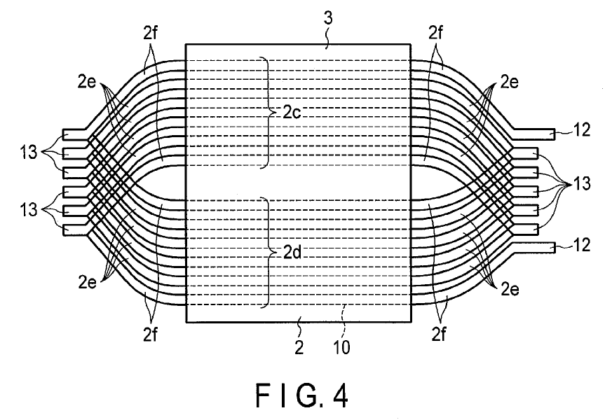

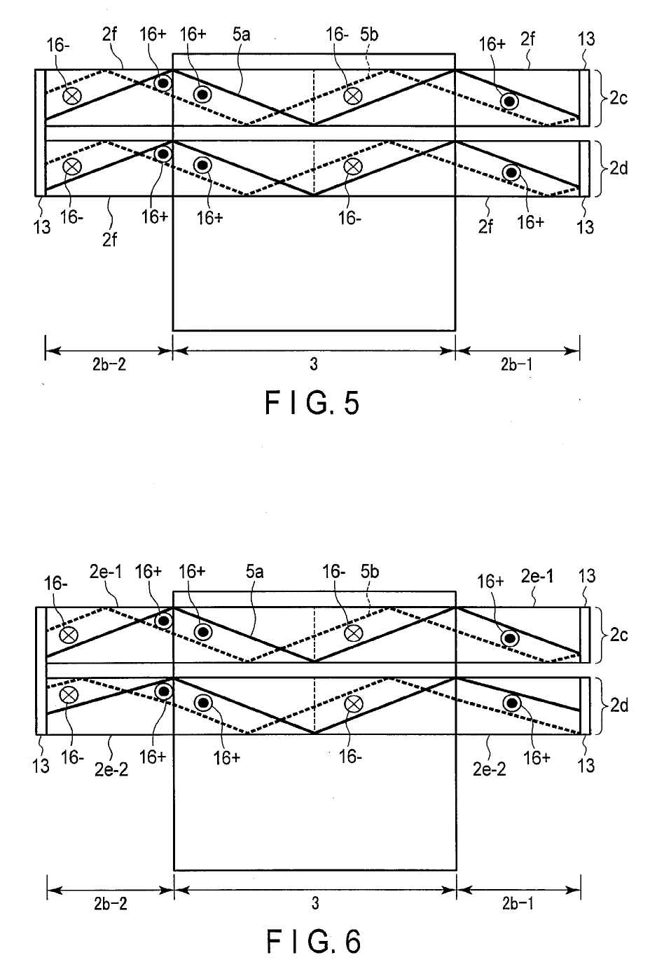

FIG. 4 is a schematic development depicting one phase of an armature winding for an electrical rotating machine in a second embodiment. FIG. 5 is a schematic diagram illustrating wire transposition of the armature winding 2 in the electrical rotating machine in the second embodiment as viewed in the circumferential direction. Elements in FIG. 4 and FIG. 5 which are the same as the corresponding elements in FIG. 1 and FIG. 2, described above, are denoted by the same reference numerals, and duplicate descriptions are omitted.

In the present embodiment, at each of the coil-piece end portions 2b-1 and 2b-2, the wire transposition angle of the coil-piece end portion 2f positioned at an end of a phase belt (the coil-piece end portion facing a boundary portion between different phase belts) is larger than the wire transposition angle of the coil-piece end portion 2e in a central portion of the phase belt (the coil-piece end portion not facing the boundary portion) as depicted in FIG. 4.

The wire transposition of the coil-piece end portion 2e is similar to the wire transposition depicted in FIG. 10 described above, and has a wire transposition angle of, for example, 90°. In contrast, the wire transposition of the coil-piece end portion 2f is as depicted in FIG. 5, and has a wire transposition angle of, for example, 120°.

As described above, in the second embodiment, the wire transposition angle of the coil-piece end portion 2f positioned at the end of the phase belt is larger than the wire transposition angle of the coil-piece end portion 2e in the central portion of the phase belt. This enables a reduction in the circulating current loss at the coil-piece end portion positioned at the end of the phase belt, which involves a large amount of impinging fluxes. Thus, a rise in temperature can be leveled off, providing a more reliable armature winding for an electrical rotating machine and a more reliable electrical rotating machine.

In the present embodiment, the wire transposition angle is increased for every other coil-piece end portion at the end of the phase belt. However, the number of coil-piece end portions for which the wire transposition angle is increased may be changed depending on a difference in the amount of impinging fluxes. There is a certain degree of freedom for the number of such coil-piece end portions and the degree of a change in wire transposition angle; the wire transposition angle may be gradually varied from the end to the central portion of the phase belt.

In the illustrated example of the present embodiment, each wire is transposed from end to end of the coil-piece end portion. The transposition may be partly omitted or the transposition angle may be partly changed. For example, instead of being uniform (for example, at 120°), the wire transposition angle of the coil-piece end portion 2f may be zero or may be changed (for example, to 90°) within an area from the core side to the middle of the coil-piece end portion 2f.

### Third Embodiment

FIG. 6 is a schematic diagram illustrating wire transposition of the armature winding 2 in the electrical rotating machine in the third embodiment as viewed in the circumferential direction. Elements in FIG. 6 which are the same as the corresponding elements in FIG. 2 and FIG. 5, described above, are denoted by the same reference numerals, and duplicate descriptions are omitted.

In the present embodiment, at each of the coil-piece end portions 2b-1 and 2b-2, the wire transposition angle of a coil-piece end portion 2e-1 of the upper coil pieces 2c is larger than the wire transposition angle of a coil-piece end portion e-2 of the lower coil pieces 2d as depicted in FIG. 6.

The wire transposition of the coil-piece end portion 2e-2 of the lower coil pieces 2d is similar to the wire transposition depicted in FIG. 10 described above, and has a wire transposition angle of, for example, 90°. In contrast, the wire transposition of the coil-piece end portion 2e-1 of the upper coil pieces 2c is as depicted in FIG. 6, and has a wire transposition angle of, for example, 120°.

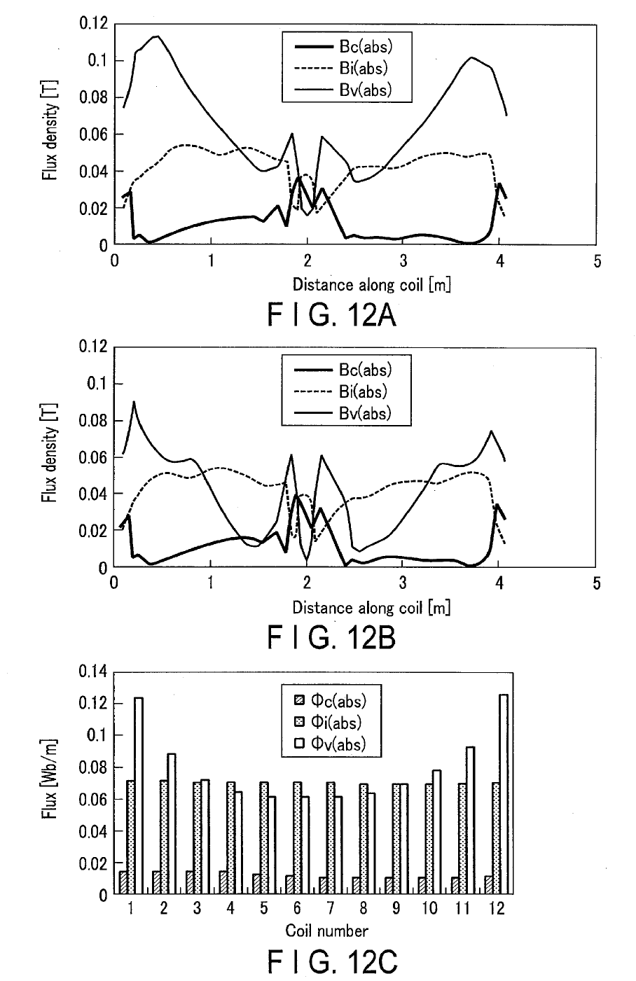

The degree of a reduction in loss varies according to design conditions or operating conditions for the electrical rotating machine. Thus, the optimum wire transposition angle is desirably determined under individual conditions by numerical analysis. However, in general, the trend illustrated in FIG. 3 may remain substantially unchanged even with a change in conditions, and a difference in the amount of impinging fluxes between the upper coil pieces 2c and the lower coil pieces 2d may be larger than such a difference in the position of the phase belt as depicted in FIG. 12. Thus, the difference in wire transposition angle is desirably within the range of 30° to 120°.

As described above, in the third embodiment, the wire transposition angle of the coil-piece end portion 2e-1 of the upper coil pieces 2c is larger than the wire transposition angle of the coil-piece end portion 2e-2 of the lower coil pieces 2d. This enables a reduction in the circulating current loss at the coil-piece end portion 2e-1, which involves a high impinging flux density. Thus, a rise in temperature can be leveled off, providing a more reliable armature winding for an electrical rotating machine and a more reliable electrical rotating machine.

In the illustrated example of the present embodiment, each wire is transposed from end to end of the coil-piece end portion. The transposition may be partly omitted or the transposition angle may be partly changed. For example, instead of being uniform (for example, at 120°), the wire transposition angle of the coil-piece end portion 2e-1 may be zero or may be changed (for example, to 90°) within an area from the core side to the middle of the coil-piece end portion 2e-1.

As described above in detail, each of the embodiments enables a reduction in a circulating current between the wire conductors induced by a difference in interlinkage fluxes between the wires in the coil piece, allowing suppression of an increase in loss from the armature winding and local overheat.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An armature winding for an electrical rotating machine comprising:
a plurality of coil pieces partly housed in a plurality of winding slots formed in a stator core, each coil piece comprising a plurality of wire conductors which are formed to be transposed by being twisted,
wherein at least some of coil-piece end portions protruding outward from side surfaces of the stator core are configured to have different wire conductor transposition angles according to an amount of impinging fluxes or an impinging flux density.

2. The armature winding for the electrical rotating machine according to claim 1, wherein a transposition angle of the wire conductors of the coil-piece end portions protruding outward from one side surface of the stator core is larger than a transposition angle of the wire conductors of the coil-piece end portions protruding outward from another side surface of the stator core.

3. The armature winding for the electrical rotating machine according to claim 1, wherein, for the coil-piece end portions protruding outward from one of opposite side surfaces of the stator core, a transposition angle of the wire conductors of longer coil-piece end portions is larger than a transposition angle of the wire conductors of shorter coil-piece end portions.

4. The armature winding for the electrical rotating machine according to claim 1, wherein a transposition angle of the wire conductors of the coil-piece end portions protruding outward from one side surface of the stator core is 30° to 60° larger than a transposition angle of the wire conductors of the coil-piece end portions protruding outward from another side surface of the stator core.

5. The armature winding for the electrical rotating machine according to claim 1, wherein, for the coil-piece end portions protruding outward from opposite side surfaces of the stator core, a transposition angle of the wire conductors of those of the coil-piece end portions which face a boundary portion between different phase belts is larger than a transposition angle of the wire conductors of those of the coil-piece end portions which do not face the boundary portion.

6. The armature winding for the electrical rotating machine according to claim 1, wherein, for the coil-piece end portions protruding outward from opposite side surfaces of the stator core, a transposition angle of the wire conductors of those of the coil-piece end portions which face a boundary portion between different phase belts is 30° to 60° larger than a transposition angle of the wire conductors of those of the coil-piece end portions which do not face the boundary portion.

7. The armature winding for the electrical rotating machine according to claim 1, wherein, for the coil-piece end portions protruding outward from opposite side surfaces of the stator core, a transposition angle of the wire conductors of those of the coil-piece end portions which are housed in an opening side of the winding slots is larger than a transposition angle of the wire conductors of those of the coil-piece end portions which are housed in a bottom side of the winding slots.

8. The armature winding for the electrical rotating machine according to claim 1, wherein, for the coil-piece end portions protruding outward from opposite side surfaces of the stator core, a transposition angle of the wire conductors of those of the coil-piece end portions which are housed in an opening side of the winding slots is 30° to 120° larger than a transposition angle of the wire conductors of those of the coil-piece end portions which are housed in a bottom side of the winding slots.

9. An electrical rotating machine comprising the armature winding according to claim 1.
